(19) United States
(12) Patent Application Publication
(10) Pub. No.: US 2026/0196578 A1
(43) Pub. Date: Jul. 9, 2026

(54) IMPROVED COMMUNICATION DEVICE FOR BATTERY PACKS

(71) Applicant: DUKOSI LIMITED, Edinburgh (GB)

(72) Inventors: Joel SYLVESTER, Edinburgh (GB); Daniel DECLE COLIN, Edinburgh (GB)

(21) Appl. No.: 19/133,669

(22) PCT Filed: May 26, 2023
(86) PCT No.: PCT/EP2023/064294

§ 371 Date: May 28, 2025

(30) Foreign Application Priority Data
Nov. 29, 2022 (GB) 2217938.6

(51) Int. Cl. H01M 10/42; H01M 50/284; H04B 1/12; H04B 5/26; H04B 5/28; H04B 5/43; H04B 5/72

(52) U.S. Cl. CPC H01M 10/425; H01M 50/284; H04B 1/12; H04B 5/263; H04B 5/28; H04B 5/43; H04B 5/72; H01M 2010/4278

(57) ABSTRACT

An assembly for use with a battery pack comprising a plurality of battery cells is provided. The assembly enables communication between an electronic device and a radio transceiver located remotely from the electronic device. The assembly comprises: a module antenna operatively connected to the electronic device, the module antenna comprising a first coil and a second coil of an electrical conductor; a bus antenna configured in use to provide a communication channel for the radio transceiver, the bus antenna comprising two transmission lines, each one of the transmission lines being spaced apart from and positioned adjacent to a different one of the first and second coils, to enable near-field coupling between the module antenna and the bus antenna when a transmission signal is input into either the module antenna or the bus antenna; and wherein the arrangement of the two transmission lines relative to the coils is such that an induced current in each transmission line caused by the coupling of each transmission line with its adjacent coil, is substantially the same in magnitude.

### TECHNICAL FIELD

The present disclosure relates to the field of batteries and battery cells. Embodiments of the disclosure relate to assemblies for use with battery packs comprising a plurality of battery cells, the assemblies enabling wireless communication between electronic devices within the battery packs and a battery management system (BMS) comprising a radio transceiver located remotely from the electronic device.

### BACKGROUND

Battery systems, comprising a plurality of battery cells, are used in a wide variety of modern electric power applications. For example, they are used to power electric vehicles, they are used in industrial power applications, in transportation, and commercial applications such as powering of modern electronic devices. Given the relatively high-power demands of such applications, a battery system often comprises a plurality of battery cells coupled together to achieve the required power and/or voltage output. The battery cells may be coupled together to form a battery pack, and the battery system may comprise one or more battery packs.

It is common practice to connect a battery system to a battery management system (BMS) which is configured to ensure that the battery system operates within its safe operating range. The safe operating range is defined as the temperature, voltage, and current conditions under which the battery system is expected to operate without self-damage. A BMS may include one or more Cell Monitoring Devices (CMDs) configured to monitor at least one battery cell and report back to the BMS. A CMD typically consists of an electronic device that may be configured to measure physical characteristics at the battery cell level, such as current, voltage, temperature, and other characteristics useful in determining the condition of a battery cell.

As a result, BMS's typically include communication means between each CMD and the management circuitry of the BMS. However, given the high-voltage environment in which BMS's and the CMD's are deployed, to ensure fault-free operation, it is necessary to ensure that such systems provide high voltage isolation and EMI (electromagnetic interference) immunity performance. High voltage isolation is required in respect of communication signals transmitted between individual battery cells or packs and the BMS, because each battery cell or pack sits at different voltages relative to the system ground. The voltage variation from the system ground can reach hundreds of volts in a typical battery system. Therefore, kilovolt isolation may be required. Additionally, electromagnetic interference can couple with the communication signals transmitted between the CMDs and the BMS, disrupting the communication signal or directly interfering with it. Since high-voltage battery systems are strong sources of EMI, the immunity performance of a communication system deployed within a battery pack is important.

Known applications to signal communication within a battery system, include isolated wired communication protocols such as CAN bus, or wireless communication protocols such as WiFi or ZigBee. Although both approaches address the isolation problem, wired communication protocols do not directly address the EMI problem, and require more cumbersome assembly. The use of WiFi or ZigBee, which involves the use of far-field communication protocols, require that each antenna in the battery system be separated by a plurality of wavelengths at which the radio frequency operates, in order to function optimally. These solutions may not fit the typical dimensions of many battery systems.

It is an object of at least some embodiments of the present disclosure to address one or more of the shortcomings of the prior art and, in particular, to provide a more convenient means for enabling communication with a BMS within a battery system, which benefits from high voltage isolation, and electromagnetic interference immunity.

### SUMMARY

In accordance with an aspect of the disclosure there is provided an assembly for use with a battery pack comprising a plurality of battery cells, the assembly being suitable for enabling communication between an electronic device and a radio transceiver located remotely from the electronic device. The assembly may comprise: a module antenna operatively connected to the electronic device, the module antenna comprising a first coil and a second coil of an electrical conductor; a bus antenna configured in use to provide a communication channel for the radio transceiver, the bus antenna comprising two transmission lines, each one of the transmission lines being spaced apart from and positioned adjacent to a different one of the first and second coils, to enable near-field coupling between the module antenna and the bus antenna when a transmission signal is input into either the module antenna or the bus antenna. The arrangement of the two transmission lines relative to the coils is such that an induced current in each transmission line caused by the coupling of each transmission line with its adjacent coil, is substantially the same in magnitude.

In accordance with other aspects of the disclosure, there are provided a battery cell comprising the aforementioned assembly, and a battery pack having a plurality of battery cells and comprising the aforementioned assembly.

### BRIEF DESCRIPTION OF THE DRAWINGS

Specific embodiments of the disclosure will be described in more detail below with reference to the accompanying drawings, in which like-numbered reference numerals appearing in different drawings, refer to the same components and/or steps. The drawings are not drawn to scale.

FIG. 1 is a schematic illustration of a battery system, in accordance with an embodiment of the disclosure.

FIG. 2A is a schematic illustration of an exemplary balanced circuit using common mode rejection.

FIG. 2B is a schematic illustration of the balanced circuit of FIG. 2A comprising baluns.

FIG. 3 represents a schematic illustration of an exemplary bus/module antenna assembly, in accordance with an embodiment of the present disclosure.

FIG. 4A is a schematic illustration of a counter-clockwise magnetic field generated by a current-carrying elongated conductor.

FIG. 4B is a schematic illustration of a clockwise magnetic field generated by a current-carrying elongated conductor.

FIG. 5A is a schematic illustration of a magnetic field generated by a current-carrying coil, in which the current flows through the coil from left to right.

FIG. 5B is a schematic illustration of a magnetic field generated by a current-carrying coil, in which the current flows through the coil from right to left.

FIG. 6A is a schematic illustration of inductive magnetic coupling between a coil and an elongated conductor, when a current is flowing in a direction out of the page through the elongated conductor.

FIG. 6B is a schematic illustration of another inductive magnetic coupling between a coil and an elongated conductor, when a current is flowing in a direction into the page through the elongated conductor.

FIG. 6C is a schematic illustration of an inductive magnetic coupling between a coil and an elongated conductor, when a current is flowing through the coil from right to left.

FIG. 6D is a schematic illustration of another inductive magnetic coupling between a coil and an elongated conductor, when a current is flowing through the coil from left to right.

FIG. 7A is a schematic illustration of an exemplary bus/module antenna assembly in operation, in accordance with an embodiment of the present disclosure in which the coils are connected at a T-junction.

FIG. 7B is a schematic illustration of the exemplary bus/module antenna assembly of FIG. 7A, in which the coils are connected in series, in accordance with an embodiment of the present disclosure.

FIG. 7C is a schematic illustration of the exemplary bus/module antenna assembly of FIG. 7B, in which the coils are connected in series, in accordance with an alternative embodiment of the present disclosure.

FIG. 7D is a schematic illustration of an exemplary bus/module antenna assembly in which the coils are connected at a T-junction, and the bus antenna wires are configured on alternative sides of the coils, in accordance with an embodiment of the present disclosure.

FIG. 7E is a schematic illustration of the exemplary bus/module antenna assembly of FIG. 7D, in which the coils are connected in series, in accordance with an embodiment of the present disclosure.

FIG. 7F is a schematic illustration of the exemplary bus/module antenna assembly of FIG. 7E, in which the coils are connected in series, in accordance with an alternative embodiment of the present disclosure.

FIG. 8 is a schematic illustration of an exemplary bus/module antenna assembly, in which a differential pair of signals is output to the coils, in accordance with an embodiment.

FIG. 9A is a schematic illustration of an exemplary bus/module antenna assembly, in which the coils are comprised in a printed circuit board circuit arranged orthogonal to the plane of the bus antenna, in accordance with an embodiment of the present disclosure.

FIG. 9B is a schematic illustration of the exemplary bus/module antenna assembly, in which the coils are comprised in a printed circuit board arranged parallel to the plane of the bus antenna, in accordance with an embodiment of the present disclosure.

FIG. 9C is a schematic illustration of the embodiment of FIG. 8 implemented in a printed circuit board arranged orthogonal to a plane of the bus antenna.

FIG. 9D is a schematic illustration of the embodiment of FIG. 9 implemented in a printed circuit board arranged parallel to the plane of the bus antenna.

FIG. 10 is a perspective view of an exemplary battery system comprising a plurality of battery cells, each cell having a PCB comprising a module antenna affixed to it, and wherein the bus antenna is arranged orthogonal to the face of the battery cell comprising the PCB.

### DETAILED DESCRIPTION

Exemplary embodiments of the disclosure will now be described with reference to the accompanying drawings. The same reference numerals used in different drawings represent the same or similar elements unless otherwise stated. The below-described exemplary embodiments do not represent all envisaged implementations of the disclosure. Instead, they are merely non-limiting examples consistent with aspects of the disclosure as recited in the appended claims.

Embodiments of the present disclosure provide an assembly comprising an electronic device and module antenna configured local to a battery module, which enable wireless, near-field communication with a bus antenna. The bus antenna provides a signal path to a battery management system (BMS) located remotely from the battery module. Near-field communication with the bus antenna is achieved through electro-magnetic coupling between the module antenna and the bus antenna. The module antenna itself may comprise one or more coils, which enable electro-magnetic coupling with the bus antenna through a wide range of orientations of the bus antenna relative to the module antenna coils. Embodiments of the present disclosure therefore provide a convenient solution for achieving near-field communication within a battery system, which can accommodate a wide range of different orientations of battery modules within a battery system. Further details follow below, along with an explanation of the underlying principles of operation.

### Battery Management System (BMS) Overview.

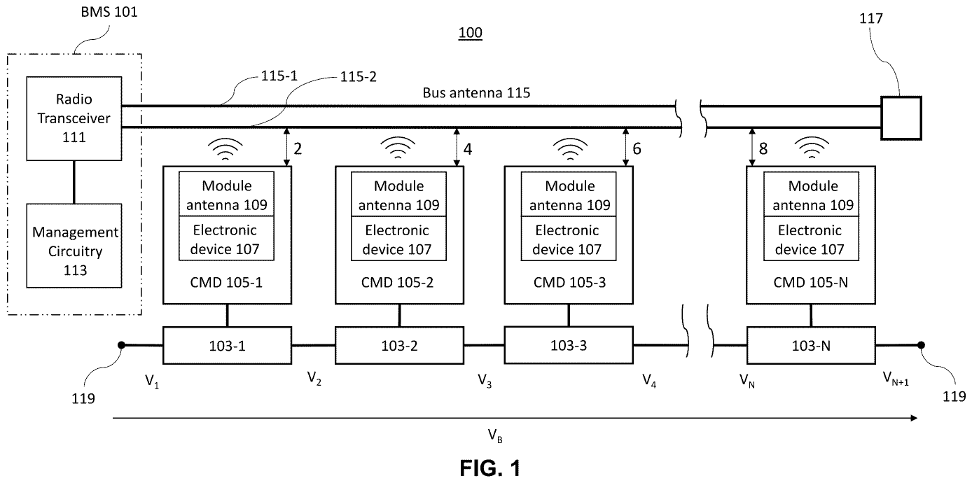

FIG. 1 is a schematic illustration of a battery system 100 in accordance with embodiments of the present disclosure. Battery system 100 comprises, but is not limited to, a plurality of battery modules 103 (labelled with an integer between 1 and N, where N is the total number of battery modules in battery system 100) a BMS 101, one or more cell monitoring devices (CMD) 105, and a bus antenna 115. In accordance with the illustrated embodiment, each battery module 103 is monitored by an associated CMD 105 (labelled with an integer in relation to the associated battery module). In alternative embodiments, each single CMD may monitor one or more different battery modules. Battery modules 103 of battery system 100 may be electrically coupled, and battery system 100 may include electrical terminals 119 for drawing electrical power from battery system 100. Battery modules 103 may comprise a single battery cell or a plurality of battery cells arranged in series, in parallel or a combination thereof. In the illustrated embodiment of FIG. 1, each CMD 105 may be configured to communicate (transmit/receive data) with BMS 101, and more specifically with BMS management circuitry 113, by near field coupling (NFC) with bus antenna 115. Bus antenna 115 may be connected to radio transceiver 111, which is itself connected to management circuitry 113 of BMS 101.

Each CMD 105 may comprise electronic device 107 and module antenna 109. Electronic device 107 may comprise, or be operatively connected to, a plurality of sensors configured to measure and monitor one or more physical characteristics (e.g. voltage, current, charge, temperature, pressure, humidity) at the battery module level or the battery cell level. Module antenna 109 may relate to any physical system capable of establishing NFC communication with bus antenna 115. Accordingly, module antenna 109 and bus antenna 115 enable communication between each electronic device 107 of each CMD 105 and radio transceiver 111, located remotely from the plurality of electronic devices 107.

In the present context, near-field coupling may be interpreted as involving a distance of separation between bus antenna 115 and each module antenna 109 of less than one wavelength of electromagnetic radiation, and more specifically less than one wavelength of the radio wave transmission signal between bus antenna 115 and module antenna 109. For example, the distance of separation may be less than 120 mm, when the wavelength is 120 mm. Stronger electromagnetic near-field coupling may occur when the separation is substantially less than one wavelength, for example, less than one-tenth of a wavelength. Battery system 100 may be configured so that each module antenna 109 is spaced from the transmission line by no more than one-half, one-third, one-quarter, one-fifth, one-sixth, one-seventh, one-eighth, one-ninth or one-tenth of the wavelength of the electromagnetic radiation. In accordance with some embodiments, the wavelength of the transmission signal may relate to any Industrial Scientific Medical (ISM) short-range radio band. Exemplary, non-limiting wavelengths may comprise 440 MHz, 828 MHz, 915 MHz, 2.4-2.5 GHz, and 5 GHz.

The use of near-field coupling may allow the plurality of module antennas 109 to be positioned close to the bus antenna 115, and module antennas 109 are less sensitive to external EMI interference than the far-field module antennas of the prior art, thereby overcoming some of the problems described above. In accordance with some embodiments, the plurality of module antennas 109 may be arranged at substantially the same distance from bus antenna 115. The transmission of communication between electronic devices 107 and radio transceiver 111 may be subject to additional constraints arising as a result of the high-voltage environment of battery system 100. As mentioned previously, these additional constraints relate to: high voltage isolation and immunity to electromagnetic interference. These two constraints are described below.

### High-Voltage Isolation

Battery system operating voltages (V_{B}) are obtained by stacking different cells or battery packs in series (as shown in FIG. 1). For most applications, these operating voltages are considered, although definitions may differ, as high voltages (V_{B}>60 V). For example, automotive batteries typically have an operating voltage of about 400 V, buses may operate at 800V, and industrial energy storage systems may operate at 1500V. As shown in FIG. 1, each battery module 103 experiences a different voltage/potential difference Vᵢ₊₁−Vᵢ (with i an integer between 1 and N) relative to the ground of battery system 100, with each Vᵢ increasing progressively. It follows that the last battery module 103-N in battery system 100 is at a higher voltage than first battery module 103-1. It may be necessary to isolate these high voltages to prevent devices within the battery system from experiencing them, that may otherwise not be able to withstand such high voltages. In particular, high-voltage isolation is required between the antenna module 109 and bus antenna 115. In FIG. 1 module antenna 109 and bus antenna 115 are separated by gaps 2, 4, 6, 8. It follows from the preceding discussion regarding the voltage each different battery module 103 experiences, that the high-voltage isolation required across gaps 2, 4, 6, 8 may in principle be different for different battery modules 103, subject to the voltage each battery module 103 is subject to. Thus, for example, the high-voltage isolation required across gap 2, between module antenna 109 of battery module 103-1 and bus antenna 115, may be less than the high-voltage isolation required across gap 8, between the module antenna 109 of battery module 103-N and bus antenna 115, since battery module 103-N may be at a higher voltage relative to battery module 103-1. Thus, a battery system 100 in which different battery modules have a different high-voltage isolation is envisaged. However, for practical purposes, it is often easier to configure each battery module 103, associated module antenna 109 and gap 2, 4, 6, 8 to satisfy the maximum high-voltage isolation that may be experienced within the battery system 100. In other words, each battery module, and more specifically the associated module antenna 109 and gap 2, 4, 6, 8, may be configured to ensure high-voltage isolation for the maximum voltage that battery module 103-N may experience.

Consider an automotive battery consisting of 96 lithium polymer cells with a maximum voltage of 4.2 V. The maximum operating voltage V_{B} of such an automotive battery is therefore 403.2 V. The automotive battery may be divided into 8 battery modules of 12 cells connected in series, each with a voltage of 50.4 V. A CMD configured to handle 60 V is therefore capable of monitoring 12 cells, but as battery packs are connected in series, each subsequent CMD should be electrically isolated from all others CMDs and associated battery modules, and in particular should be isolated from experiencing the automotive battery operating voltage V_{B}, to ensure that the maximum potential difference observed by a single CMD is less than 60 V. If two battery packs are not perfectly isolated, their respective CMD may not withstand the potential difference (of 100.8 V).

High voltage isolation requires using the correct isolation components with the proper materials, but also adherence to the correct distances in the design of the battery system to ensure that high voltage insulation is maintained in all use cases, in all environments and as the battery system ages. Two characteristic distances associated with the geometry of a battery system are decisive for ensuring high voltage isolation: clearance distance, and creepage distance. The clearance distance (IEC 60664-1) corresponds to the shortest distance in air between two conductive parts, whereas the creepage distance (IEC 60664-1) corresponds to the shortest distance along the surface of a solid insulating material between two conductive parts. To ensure a specific level of voltage isolation between two conductive parts, a specific minimum clearage/creepage distance needs to be observed. These distances are generally specified in industry standards documentation, an example of which is IEC standard 60664-1. In practice, a voltage isolation level greater than the battery operating voltage V_{B} may be selected, e.g. for a 400 V battery system, a voltage isolation level of 500 V, 1 kV or more may be appropriate.

It should be noted that high voltages represent not only a risk of damage to battery system componentry, but also present a risk of electric shock to an assembly operator or end user of the battery system. The components used for signal communication between CMDs, battery modules, and the BMS within a battery system, are closely monitored as they present potential sources of current leakage, and the associated risks increase with the increasing number of cells N.

### Electromagnetic-Interference Immunity and Common Mode Rejection

Electromagnetic interference (EMI) is the disturbance of electronic equipment or systems by electromagnetic radiation, electrostatic coupling, magnetic coupling or electrical conduction. It can cause malfunction, data corruption, data loss or even complete failure of the affected equipment. EMI may be caused by a variety of different sources, including power lines, radio waves and even household appliances. Within the context of a battery system, the high voltages and currents present, are strong sources of EMI, and electronic components such as CMDs or other circuitries are susceptible to EMI. Shielding, filtering, and grounding are common methods used to reduce the effects of EMI on electronic systems.

In accordance with embodiments of the disclosure, the approach taken to reduce EMI resides in the use of balanced electrical paths and common mode rejection. For an electrical signal to propagate, there must be a return path. In an unbalanced system, a first conductor is provided to propagate a signal, and the return path is referred to as the ground connection. In a balanced system, a second conductor is provided to propagate the same signal as the first conductor, but with opposite polarity (e.g. same magnitude, but opposite phase). The second conductor is the return path for the first conductor, and vice versa.

In a balanced system, there are two modes of signal propagation. The first mode is differential, where the signal of interest is determined by the difference in signals propagating on the two conductors. The second mode is common mode, where the signal of interest is the signal that appears on both conductors. In a balanced system, EMI is usually coupled to the common mode, and noise filtering may be required to remove it. In contrast, when operating in differential mode, the signals are of opposite polarity, and the output is determined by calculating the difference of the two opposite polarity signals propagating on each conductor. Any EMI which couples to the two conductors may effectively be removed or filtered out, when the signal difference is determined. The magnitude and polarity of the induced EMI in each conductor is essentially the same, since the two conductors are located close together relative to the distance of the source causing the EMI. Thus, when the difference of the two EMI noise affected signals propagating in the two conductors is determined, the induced EMI noise cancels. In this way, a desired signal may be transmitted without traces of EMI in the differential mode conductor. In practice, determining the difference of the opposite polarity two signals propagating on the two conductors may require a signal subtractor. In other words, a device that receives as its input the two differential signals, and outputs their difference, which is the signal of interest. A differential receiver may be used to determine the difference. Similarly, differential amplifier is another example of a signal subtractor, albeit the differential amplifier outputs an amplified difference signal. Conversely, generating differential signal for input to two conductors may require a differential output block such as an input signal splitter and inverter, a differential output amplifier or a phase splitter. The signal splitter separates an input signal V_{dm} into two equal magnitude signals V_{dm}/2. The inverter inverts the polarity of one of the split signals (i.e. −V_{dm}/2). The end result is that two signals of opposite polarity are provided (i.e. equal magnitude but opposite phase), that may be input on separate conductors, thus forming a differential pair of signals. Functionally, the splitter-inverter performs the inverse of the subtractor-provided with a single input signal, it splits it into two signals and inverts the polarity of one of them. In contrast, the subtractor provided with a differential pair of signals, determines the difference by subtracting the two differential signals to output the difference signal.

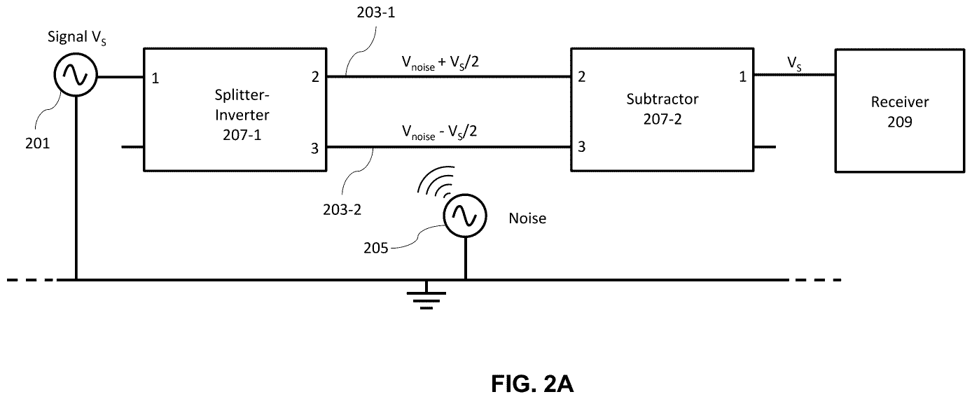

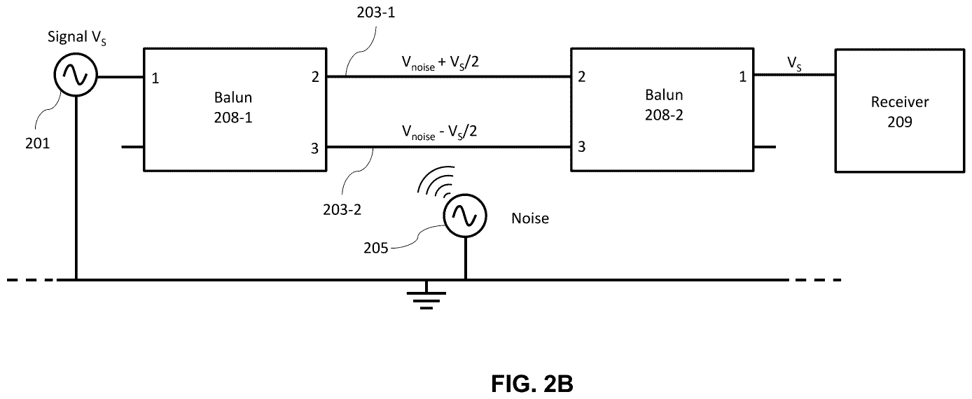

FIG. 2A is a schematic illustration of an exemplary balanced circuit using common mode rejection. A signal source 201 provides an input signal V_{S} to be transmitted to a receiver 209. The circuit comprises a first 203-1 and second 203-2 balanced conductor. Differential signals V_{S}/2 and −V_{S}/2 are generated using splitter-inverter 207-1, for input signal V_{S}. First differential signal V_{S}/2 is output to first conductor 203-1 and second (inverted) differential signal −V_{S}/2 is output to second conductor 203-2. If the circuit is not perfectly immune to EMI, both first 203-1 and second 203-2 conductors may experience an interference/noise signal Vₙₒᵢₛₑ from a nearby noise source 205. However, because both conductors are balanced, the resulting signal propagating along first conductor 203-1 is equal to Vₙₒᵢₛₑ+V_{S}/2, and that on second conductor 203-2 is equal to Vₙₒᵢₛₑ−V_{S}/2. The two resulting signals are input to subtractor 207-2, where the difference signal is output from subtractor 207-2 and input to receiver 209. Thus, at the receiver 209, a signal proportional to the difference between the two resulting signals from first 203-1 and second 203-2 conductors is measured, i.e., Vₙₒᵢₛₑ+V_{S}/2−Vₙₒᵢₛₑ−(−V_{S}/2)=V_{S}. The common mode interference/noise signal Vₙₒᵢₛₑ has been removed. As mentioned previously, the function of the subtractor 207-2 may be provided by a differential amplifier, in which case the output signal received at the receiver 209 is amplified, i.e. GV_{S}, where G represents the gain of the differential amplifier. The measure of a differential amplifier's ability to eliminate common-mode voltage is known as the common-mode rejection ratio, or CMRR.

The differential operations on the first 203-1 and second 203-2 conductor signals may be performed using baluns 208, as illustrated in FIG. 2B. In other words, in accordance with some embodiments, the function of splitter-inverter 207-1 and subtractor 207-2 of FIG. 2A may be provided by baluns 208. Baluns 208 are reciprocal three-port power splitters comprising one unbalanced port and two balanced ports, illustrated respectively in FIG. 2B as port 1 and ports 2 and 3. Signals at the balanced ports are equal and opposite (frequency domain: π phase shift—temporal domain: one balanced port signal is the opposite of the other balanced port signal). Baluns 208 are designed to equally split the energy of a signal fed to the unbalanced port between the two balanced ports, reciprocally baluns are able to combine at the unbalanced port a differential signal applied to the balanced ports. In the example shown in FIG. 2B, balun 208-1 splitts source signal V_{S} applied to the unbalanced port 1, whereas balun 208-2 combines the differential signal applied to balanced ports 2 and 3. Receiver 209, which may relate to a radio transceiver, commonly possess only one unbalanced input/output port. To use balanced communication with common mode rejection, a balun with a sufficient CMRR may be required. In accordance with at least some embodiments of the present disclosure, it is to be appreciated that whilst a balun may relate to a hardware device, the functionality provided by the balun may also be provided by alternative means. In particular, and as is described in the below description of exemplary embodiments, the functionality of the balun 208 may be provided by the configuration of module antenna 109 and bus antenna 115 of FIG. 1. More specifically, and applying the principles of FIG. 2B to the battery system of FIG. 1, in accordance with at least some embodiments of the disclosure, when a signal is transferred from cell monitoring device 105 to BMS 101, electromagnetic coupling of module antenna 109 with bus antenna 115 provides the functionality of balun 208-1 of FIG. 2B, and radio transceiver 111 provides the functionality of balun 208-2. To achieve this, radio transceiver 111 at BMS 101 may be provided with a balun, or other subtractor devices, such as a differential amplifier. Further implementation details, in accordance with embodiments of the disclosure follow. Alternatively, bus antenna 115, may be bidirectional, i.e. a transmission signal may be transmitted from any of CMDs 105 to BMS 101, or from BMS 101 to any of CMDs 105. In this latter situation, CMD 105 corresponds to the receiver and radio transceiver 111 corresponds to the source, the electromagnetic coupling of module antenna 109 with bus antenna 115 provides the functionality of balun 208-2 of FIG. 2B, and radio transceiver 111 provides the functionality of balun 208-1. To achieve this, radio transceiver 111 at BMS 101 may be provided with a block that provides a differential output, such as a splitter inverter, a differential output amplifier, or a balun.

### NFC Communication Assembly

Returning to FIG. 1, and in accordance with embodiments of the present disclosure, an assembly comprising bus antenna 115 and module antenna 109, adopting near-field communication is provided. The assembly enables communication with BMS 101, and specifically between at least one electronic device 107 of a respective CMD 105 and radio transceiver 111 of BMS 101. Such an assembly addresses both the high-voltage (HV) isolation and EMI issues simultaneously. Another advantage of near-field coupling is that the value of the coupling strength may easily be adjusted to achieve weak coupling. The weak coupling may be set so as not to overload bus antenna 115. Use of weak coupling is advantageous in that it enables a large number of CMDs 105 (e.g. N>200) to be spaced along bus antenna 115, without overloading it or changing its characteristics. Module antenna 109 may be operatively coupled to electronic device 107, and bus antenna 115 may be configured for operative communication with radio transceiver 111. Module antenna 109 and bus antenna 115 are arranged with respect to each other to enable near-field coupling there between when a transmission signal is input into either module antenna 109 or bus antenna 115. In other words, the herein disclosed assembly enables two-way communication between CMD 105 and BMS 101. Within the present context, a transmission signal may correspond to an electrical signal characterized by at least one of voltage, current, power, frequency of wavelength. For example, the transmission signal may, in some non-limiting embodiments, corresponds to a radio wave having a frequency between 2.4 and 2.5 GHZ, although, and as should be clear from the preceding description, this frequency range is by no means limiting, and any desired frequency may be selected, and more specifically any desired ISM band may be used.

As shown in FIG. 1, bus antenna 115 may comprise at least two transmission lines 115-1 and 115-2. A transmission line may refer more generically to any elongated conductor enabling the transmission of a signal; thus, examples of transmission lines may include a cable, a wire, a cable from a twisted pair or a microstrip. In accordance with some embodiments, bus antenna 115 may comprise more than two transmissions lines. Thus, for present purposes, whilst the remaining embodiments are described with respect to a bus antenna having two transmission lines, it is to be appreciated that the bus antenna may comprise more than two transmission lines. In such embodiments, it is envisaged that the one or more additional transmission lines have a different, negligible or no near-field coupling strength with module antenna 109 (e.g., a ground line). In accordance with some embodiments, bus antenna 115 may also include termination 117 (FIG. 1), that may be located at one end of bus antenna 115 opposite the end radio transceiver 111 (as shown in FIG. 1) is connected to. Bus antenna 115 may be configured such that, substantially all of the energy in the transmission line that is not coupled to module antennas 109, is absorbed by termination 117. Termination 117 may include any electrical device configured to match a characteristic impedance of the two transmission lines 115-1/2, such as a resistor. According to some embodiments, and as described in the preceding section, the two transmission lines 115-1, and 115-2 of bus antenna 115 may be configured as a balanced circuit, such that an electrical signal propagating in a first one of the two transmission lines is a radians out of phase with respect to an electrical signal propagating in a second one of the transmission lines.

In some embodiments, and as previously stated, module antenna 109 and bus antenna 115 may form a balun in operation. In this scenario, the transmission signal may comprise an unbalanced electrical signal input to module antenna 109, which is output as a balanced electrical signal at bus antenna 115. This is the scenario when a transmission signal is being transmitted from module antenna 109 to bus antenna 115. Where instead a transmission signal is being sent from bus antenna 115 to module antenna 109, the transmission signal may comprise a balanced electrical signal input to bus antenna 115, which is output as an unbalanced electrical signal at module antenna 109. In this situation, advantageously, EMI immunity is reinforced by common mode rejection.

### Assembly Architecture

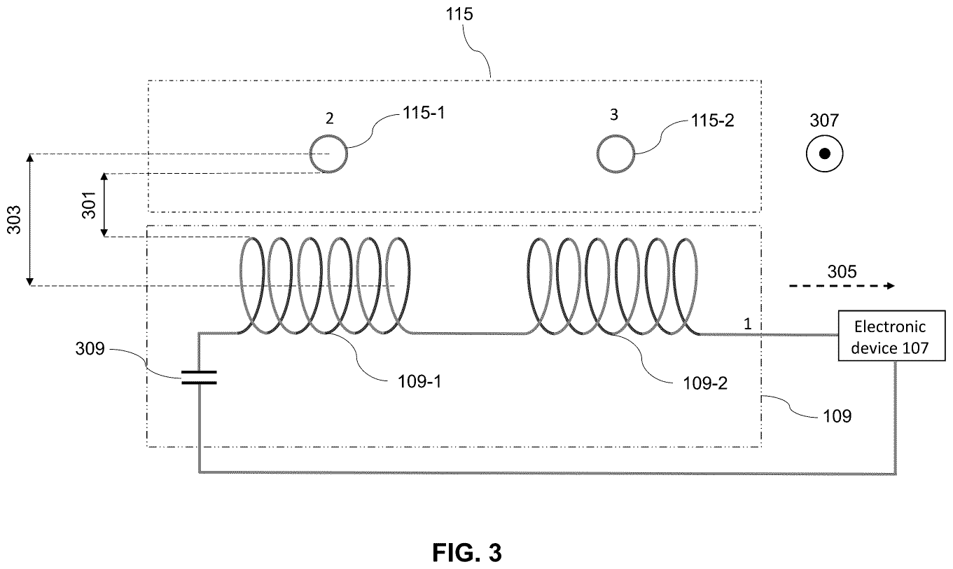

Now that the principles of operation of the present disclosure have been provided, more specific details of the assembly architecture are provided. FIG. 3 represents a schematic illustration of an exemplary bus/module antenna assembly, consistent with the disclosed embodiments. In particular, FIG. 3 illustrates how electromagnetic coupling may be achieved between module antenna 109 and bus antenna 115. Module antenna 109 comprises a first 109-1 and a second 109-2 coil of an electrical conductor. As mentioned above, bus antenna 115 comprises at least two transmission lines 115-1 and 115-2. Each one of the transmission lines 115-1, 115-2 is spaced apart from and positioned adjacent to one of the first 109-1 and second 109-2 coils of module antenna 109, to enable near-field coupling when a transmission signal is present in either the bus antenna 115 or the module antenna 109. The two transmission lines 115-1, and 115-2 are arranged relative to coils 109-1, and 109-2 such that an induced current in each transmission line caused by the coupling of each transmission line with its adjacent coil is substantially the same. In other words, when a transmission signal is input into module antenna 109, and by extension to first 109-1 and second 109-2 coils, the magnitude of an induced current generated in each transmission line 115-1, 115-2 is substantially the same. In the context of the present disclosure, a coil adjacent to a transmission line may refer to the coil closest to the transmission line, for example as illustrated in FIG. 3, first coil 109-1 is adjacent to transmission line 115-1, and second coil 109-2 is adjacent to the transmission line 115-2. Additionally, or alternatively, the two transmission lines 115-1, 115-2 may be arranged relative to coils 109-1, 109-2 such that an induced current in each one of first 109-1 and second 109-2 coils caused by the coupling of each transmission line with its adjacent coil is substantially the same (transmission signal input to bus antenna 115). Within the present context, two substantially identical magnitudes may refer to two values whose relative difference is less than a predetermined percentage. For example, two values of induced current may be substantially identical if they differ by less than 1%, 2%, or 5%. Additionally, or alternatively, the proximity of the induced currents in magnitude may be expressed in terms of the CMRR. This is explained below.

Where module antenna 109 and bus antenna 115 form a balun in operation, the balanced ports (ports 2 and 3) are formed by the two transmission lines 115-1, 115-2, and transmissions lines 115-1 and 115-2 form a balanced circuit. The unbalanced port (port 1) is formed by the first 109-1 and second 109-2 coils, which are electrically connected. The level of balance between the two transmission lines 115-1, and 115-2 is related to the ability of the assembly to generate an induced current in each transmission line with a substantially identical magnitude, although with a phase shift of π radians. The closer the value of the induced currents in each transmission line, the higher the level of balance and the better the CMRR of the balun formed by bus antenna 155 and module antenna 109. For example, according to some embodiments, the balance level between the two balanced ports may be configured to yield a CMRR greater than or equal to 0, 10 dB, 20 dB or more.

The unbalanced port (port 1) may be operatively connected to electronic device 107. In accordance with some embodiments, first 109-1 and second 109-2 coils are connected in series or connected in parallel branches. For example, when connected in parallel, the coils may be connected by an extraordinary node forming a T-junction. The two parallel branches may comprise one or more electrical components (e.g., a capacitor) in addition to the coils 109-1, 109-2. Accordingly, the unbalanced port (port 1) is either located at one of the two ends of first 109-1 and second 109-2 coils connected in series or at a branch of the extraordinary node different from the branches connected to first 109-1 and second 109-2 coils. In the example of FIG. 3, first 109-1 and second 107-2 coils are connected in series.

For a current to flow in either first 109-1 or second 109-2 coil, module antenna 109 needs to be placed in a closed electric circuit. In the example of FIG. 3, module antenna 109 and electronic device 107 form a closed circuit. One or more additional electronic components may be included in this closed circuit. For example, according to some embodiments, the first 109-1 and second 109-2 coils may be connected to capacitor 309. In FIG. 3, capacitor 309 is connected in series with first 109-1 and second 109-2 coils. Alternatively, capacitor 309 may be connected in parallel with first 109-1 and second 109-2 coils. The capacitive characteristics of capacitor 309 may be selected to tune the resonance frequency of the closed circuit of module antenna 109.

Near-field coupling strength between bus antenna 115 and module antenna 109 is related to the magnitude of the induced current in either bus antenna 115 or module antenna 109, as well as characteristic impedance values and resonance frequencies of bus antenna 115 and module antenna 109 circuits. The greater the magnitude of the induced current, the greater the magnitude of the near-field coupling strength.

Near-field coupling strength and, by extension, the magnitude of the induced current in bus antenna 115 or module antenna 109, depends on a distance of separation 303 between each of the bus antenna transmission lines 115-1, 115-2 and its adjacent coil. Near-field coupling strength is expected to be greater as distance of separation 303 decreases, therefore distance of separation 303 may be selected to tune the value of the near-field coupling strength. In accordance with some embodiments, each one of bus antenna transmission lines 115-1, 115-2 may be located equidistant relative to a different one of coils 109-1, 109-2 of module antenna 109. For example, as illustrated in FIG. 3, distance of separation 303 between first coil 109-1 and transmission line 115-1, is substantially the same as the distance of separation between second coil 109-2 and transmission line 115-2. Notwithstanding the above, alternative embodiments are also envisaged in which each separation distance between bus antenna transmission lines 115-1, 115-2 and their adjacent coil is different. In accordance with some embodiments, distance of separation 303 between each one of the bus antenna transmission lines and its adjacent coil may be selected to achieve a coupling strength greater than or equal to −50 dB, and less than or equal to −10 dB. Alternatively, distance of separation 303 may be selected to achieve a coupling strength greater than or equal to −40 dB, and less than or equal to −20 dB, or a coupling strength greater than or equal to −35 dB and less than or equal to −25 dB. In some embodiments, the coupling strength may be approximately −30 dB.

Distance of separation 303 may also be selected as a function of the clearance/creepage distance 301. As a specific clearance/creepage distance 301 is required to ensure a certain level of voltage isolation, a minimum distance of separation 303 may be required. The differentiation between clearance and creepage distance depends on the nature of the material that separates each of the transmission lines of the bus antenna and its adjacent coil. In accordance with some embodiments, each one of the bus antenna transmission lines and its adjacent coil may be separated by a dielectric insulating material. Examples of dielectric insulating material may include any one or more of: air, a plastic material, a glass-filled plastic material, an epoxy composite material, polyethylene terephthalate “PET”, acrylonitrile butadiene styrene “ABS”, polytetrafluoroethylene “PTFE”, polyvinyl chloride “PVC”, polybutylene terephthalate “PBT”, polyethylene “PE”, polyamide “PA”, FR4, ceramic-filled polytetrafluoroethylene “PTFE”, ceramic laminates, or mylar. In the example of FIG. 3 each bus antenna transmission line 115-1, 115-2 and its adjacent coil are separated by air. In accordance with some embodiments, the dielectric insulating material may be selected to have a dielectric breakdown voltage greater than the operating voltage of the battery system. Dielectric breakdown voltage is the voltage at which a dielectric material undergoes a significant increase in its electrical conductivity, resulting in the breakdown of its insulating properties. For example, if the operating voltage V_{B} of a battery system is equal to 400 V, and the distance of separation between each one of the bus antenna transmission lines 115-1, 115-2 and its adjacent coil is 4 mm, a material with a dielectric breakdown voltage with a minimum breakdown voltage of 100 V/mm may be used to address the high voltage isolation issue. In practice, it is common to select a material with a dielectric breakdown voltage orders of magnitude greater than the required dielectric breakdown voltage. In the above example, it would be common to select a dielectric material having a dielectric breakdown voltage of several kV/mm, for added safety. Examples of such material are listed above, e.g., Mylar has a dielectric breakdown voltage equal to 7 kV/mm.

First 109-1 and second coils 109-2 have one or more coil characteristics, such as a cross-section coil area, a number of turns of the electrical conductor, an electrical resistance, or a core material. Core material refers to the material around which a coil is wound. For example, in some embodiments, the core material may be at least one of air (air core coil), insulating material, ferrite or ceramic. Although the present disclosure primarily includes drawings comprising coils having a circular cross-section, it should be noted that the cross-section of a coil may have any shape (square, rectangular, etc.). In accordance with some embodiments, first 109-1 and second 109-2 coils may share at least one of the following characteristics: a same cross-sectional coil area, a same number of turns of the electrical conductor, a same electrical resistance, or a same core material. In the example shown in FIG. 3, first 109-1 and second 109-2 coils are made of the same electrical conductor, therefore they share the same electrical resistance. In addition, they share the same cross-sectional area, the same number of turns of the electrical conductor (6 turns), and they are both air-core coils.

Similarly, each transmission line 115-1, 115-2 has one or more transmission line characteristics such as a cross-sectional area, an electrical resistance, or a magnetic permeability. In accordance with some embodiments, bus antenna transmission lines 115-1, 115-2 may share at least one of the following characteristics: a same cross-sectional area, a same electrical resistance, a same magnetic permeability. For example, as shown in FIG. 3 the two bus antenna transmission lines 115-1, and 115-2 are identical, they both share the same cross-section, the same electrical resistance and the same magnetic permeability.

In addition, each one of first 109-1 and second 109-2 coils is characterized by a longitudinal axis 305, and a winding direction. In accordance with some embodiments, first 109-1 and second 109-2 coils may be configured to share the same longitudinal axis 305, as shown in the exemplary assembly of FIG. 3. It is convenient to orient the longitudinal axis of a coil to characterize the winding direction of the coil. In accordance with some embodiments, first 109-1 and second 109-2 coils may be wound along a same direction of rotation. Alternatively, first 109-1 and second 109-2 coils may be wound along opposite directions of rotation. In the example shown in FIG. 3, first coil 109-1 and second coil 109-2 are wound in opposite directions, first coil 109-1 is right-handed with respect to longitudinal axis 305 whereas second coil 109-2 is left-handed with respect to longitudinal axis 305. Likewise, each of the two transmission lines 115-1, 115-2 is characterized by a longitudinal axis 307. In accordance with some embodiments, the two transmission lines 115-1, and 115-2 may be substantially parallel, i.e. sharing a common longitudinal axis 307, as illustrated in FIG. 3 with longitudinal axis 307 perpendicular to the plane of the drawing. The arrangement of each transmission lines 115-1, 115-2 relative to its adjacent coil may be described using the angle between the longitudinal axis of the transmission lines 307 and the longitudinal axis of the adjacent coil 305. This angle may be different for each transmission line 115-1, 115-2. In accordance with some embodiments, for each one of the bus antenna transmission lines 115-1, 115-2, a longitudinal axis of the transmission line may be arranged perpendicular to a longitudinal axis of its respective adjacent coil, i.e. for both transmission lines the angle between the longitudinal axis of the transmission lines 307 and the longitudinal axis of the adjacent coil 305 may be equal to π/2.

Each of the aforementioned parameters (coils/transmission lines characteristics, distances of separations, and angles between coils/transmission lines longitudinal axes) has a direct impact on the value of an induced current generated by the near-field coupling. The influence of these parameters is described in the following sections which detail the inductive magnetic coupling operating between a coil and a transmission line.

### Magnetic Field Generated by a Current-Carrying Elongated Conductor.

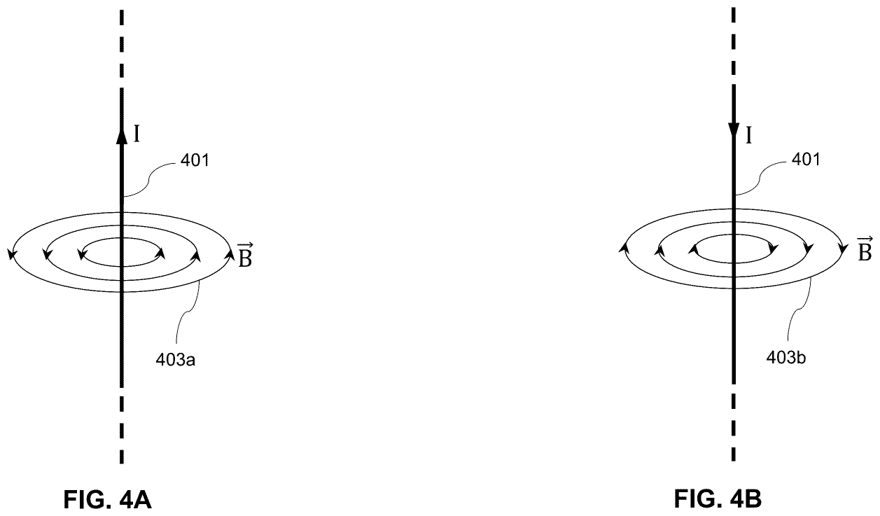

Magnetic fields arise from charges. FIGS. 4A-B illustrate different magnetic fields \vec{B} generated by a current-carrying elongated conductor 401. When a current I flows along an elongated conductor 401, a magnetic field \vec{B} is generated. The direction of the magnetic field \vec{B} may be determined using the curl right-hand rule. Given the symmetry of the system, the magnetic field lines 403a, 403b form concentric circles in a plane perpendicular to elongated conductor 401. If the current I flows from bottom to top, as shown in FIG. 4A, magnetic field lines 403a rotate counter-clockwise. In contrast, if the current I flows from top to bottom as shown in FIG. 4B, magnetic field lines 403b rotate clockwise. The magnitude B=∥B∥ of magnetic field \vec{B} produced by current-carrying elongated conductor 401 may be expressed as follows, according to the Biot-Savart law:

$$B = \frac{μ I}{2 π r}$$

where r is the shortest distance to elongated conductor 401, and μ is the magnetic permeability of the medium surrounding elongated conductor 401. Since elongated conductor 401 is considered long, the amplitude of the magnetic field \vec{B} depends only on the distance from the elongated conductor, not on the position along the elongated conductor. It is to be appreciated that whilst the figures illustrate the current vector and magnetic field lies as pointing in a single direction, this should not be construed as indicating that the currents and magnetic fields are direct or non-changing. The currents and magnetic fields are alternating, which is required for electromagnetic induction. Thus, all currents are alternating currents, and similarly all magnetic fields are alternating magnetic fields. The figures merely show the relevant vectors at a single instance in time.

### Magnetic Field Generated by a Current-Carrying Coil.

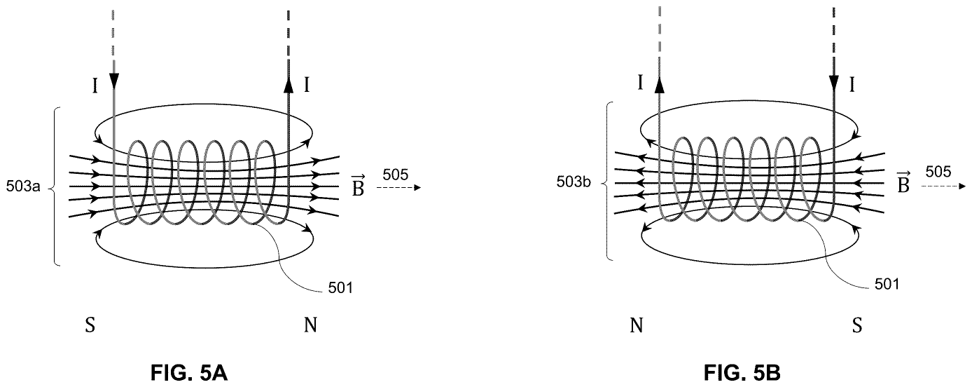

FIGS. 5A-B illustrate the magnetic field \vec{B} generated by a current-carrying coil 501. As with the current-carrying elongated conductor of FIGS. 4A & 4B, the direction and magnitude of a magnetic field \vec{B} generated by a current-carrying coil 501 may be expressed according to the Biot-Savart law, but its expression for any given point is rather complex and beyond the scope of this disclosure. This magnetic field \vec{B} is very similar to the one produced by a bar magnet and possesses certain characteristics: it flows through the centre of coil 501 along its longitudinal axis 505 and circles back around the outside of coil 501. As for a bar magnet, a north pole N and a south pole S may be defined, the field lines run from the north pole to the south pole outside coil 501 and from the south pole to the north pole inside coil 501. Depending on the direction of current I flow, the direction of the magnetic field \vec{B} (polarity of the coil) changes (right-hand rule). For the coil illustrated in FIGS. 5A-B (right-handed with respect to longitudinal axis 505) if a current I is flowing from left to right, the magnetic field \vec{B} inside coil 501 flows from left to right (FIG. 5A), in contrast, if the current I is flowing from right to left, the magnetic field B inside coil 501 flows from right to left (FIG. 5B). Note that for a coil whose direction of winding is opposite (left-handed with respect to longitudinal axis 505) to that of coil 501, the situation would be reversed. Magnetic field magnitude B is concentrated in the centre of coil 501 and weakens as one moves radially away from it. For a point located on longitudinal axis 505 of coil 501, the expression of the magnetic field magnitude B is given by:

$$B = μ nI$$

where n is the number of turns per unit of length or turn density, and μ the magnetic permeability of the medium inside the coil. With the exception of ferromagnetic materials (e.g., cobalt, nickel or iron), most materials have a permeability value very close to that of vacuum, which is why iron core solenoids are so common, a high magnetic permeability core material may greatly multiply the magnitude of the magnetic field B inside the coil.

### Inductive Magnetic Coupling.

Electromagnetic induction is a phenomenon arising when a magnetic field interacts with an electric circuit. Faraday's law of electromagnetic induction states that an electromotive force ε will be induced in a conductor subjected to a changing magnetic field, and if the conductor is a closed circuit, an induced current will flow through it. Lenz's law of electromagnetic induction states that this induced current will be such that the magnetic field created by the induced current will be opposite to the original changing magnetic field that created it. More specifically, the induced electromotive force ε is proportional to the negative rate of change of the magnetic

$$flux : ε ( t ) = - \frac{d {Θ}_{B} ( t )}{d t} with {Θ}_{B} ( t ) = \int {\int }_{S} \vec{B} . d \vec{A}$$

where d\vec{A} is surface vector element of the cross-sectional area A of the conductor. If the magnetic field is uniform over the surface S then Θ_{B}(t)=\vec{B}·\vec{A}=BAcosα, with α the angle between the unit normal vector of the surface S and the magnetic field \vec{B}, and

$$ε ( t ) = - \frac{d {Θ}_{B} ( t )}{d t} = - A cos α \frac{d B}{d t}$$

assuming that neither the area of the surface A, nor the angle α varies in time. The induced current I_{ind} in the conductor is therefore:

$${I}_{i n d} ( t ) = - \frac{1}{R} \frac{d {Θ}_{B} ( t )}{dt} = - \frac{1}{R} A cos α \frac{d B}{d t}$$

with R the electrical resistance of the conductor. Therefore, different factors influence the value of the induced current I_{ind}: the cross-sectional area of the conductor; the angle α between the unit normal vector of the cross-sectional area A and the magnetic field \vec{B}; the electrical resistance R of the conductor; the frequency of the magnetic field variations; and the magnitude of the magnetic field B.

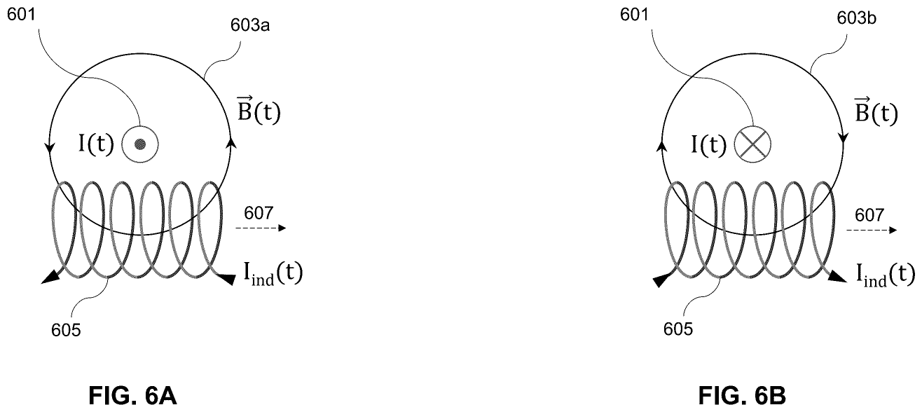

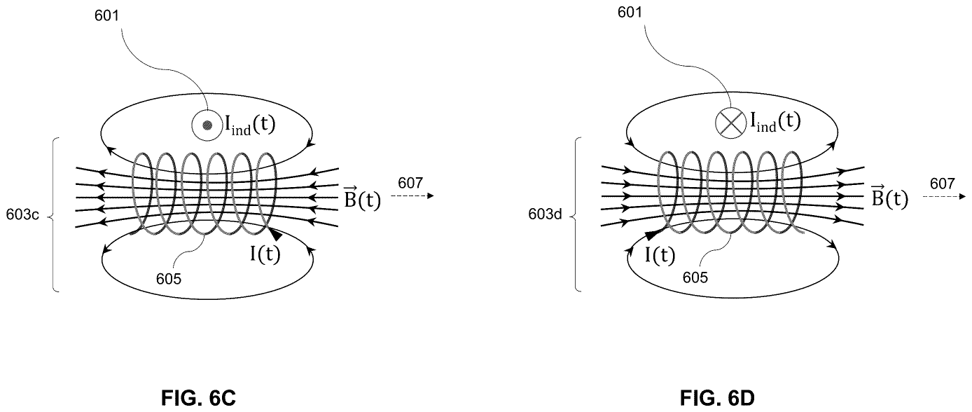

Two conductors are said to be inductively or magnetically coupled if they are configured in such a way that a varying current or source current I(t) in one conductor induces a voltage in the other conductor by electromagnetic induction, and possibly a varying induced current I_{ind}(t), if the second conductor forms a closed circuit. FIGS. 6A-B illustrate the inductive magnetic coupling that arises between an elongated conductor 601 and a coil 605, when a varying current I(t) flows in elongated conductor 601. Elongated conductor 601 and coil 605 are similar to those illustrated in FIGS. 4A-5B, although not shown here, they both form closed circuits. When a varying current I(t) flows in elongated conductor 601, a varying magnetic field \vec{B}(t) is generated, its field lines (603a, 603b) form concentric circles in a plane perpendicular to elongated conductor 601, and its magnitude is inversely proportional to the distance to elongated conductor 601. The flux of varying magnetic field \vec{B}(t) across the cross-section of coil 605, generates an electromotive force ε(t) and an induced current I_{ind}(t) in coil 605, and according to Lenz's law of electromagnetic induction the direction of induced current I_{ind}(t) will be such that a magnetic field created by induced current I_{ind}(t) will be opposite to magnetic field \vec{B}(t) generated by elongated conductor 601. In the situation illustrated in FIG. 6A, I(t) flows outwards from the figure, magnetic field lines 603a rotate counter-clockwise, and coil 605 has a magnetic field B(t) flowing from left to right, resulting in I_{ind}(t) flowing from right to left. In the situation illustrated in FIG. 6B, I(t) flows into the page, magnetic field lines 603a rotate clockwise, and coil 605 has a magnetic field B(t) flowing from right to left, resulting in I_{ind}(t) flowing from left to right.

FIGS. 6C-D illustrate the inductive magnetic coupling existing between an elongated conductor 601 and coil 605 when a varying current I(t) flows in coil 605. When a varying current I(t) flows in coil 605, a varying magnetic field \vec{B}(t) is generated, its field lines (603c, 603d) adopt a symmetry similar to the lines of a bar magnet, and its magnitude B(t) is maximal inside coil 605, and decreases as a function of the distance to coil 605 outside coil 605. The flux of this magnetic field \vec{B}(t) across the cross-section of elongated conductor 601, generates an electromotive force ε(t) and an induced current I_{ind}(t) in elongated conductor 601, and according to Lenz's law of electromagnetic induction the direction of induced current I_{ind}(t) will be such that a magnetic field created by induced current I_{ind}(t) is opposite to magnetic field \vec{B}(t) generated by coil 605. In the situation illustrated in FIG. 6C, I(t) flows from right to left, and elongated conductor 601 is subject to a magnetic field \vec{B}(t) outside coil 605 that circles back in a clockwise fashion, causing an induced current I_{ind}(t) to flow outwards from the figure. In the situation illustrated in FIG. 6D, I(t) flows from left to right, and elongated conductor 601 is facing a magnetic field \vec{B}(t) outside coil 605 that circles back in a counter-clockwise fashion, causing induced current I_{ind}(t) flowing into the figure.

The value of induced current I_{ind}(t) in either elongated conductor 601 or coil 605 is dependent on the arrangement of elongated conductor 601 with respect to coil 605, and some characteristic elongated conductor or coil parameters such as a cross-sectional area A, electrical resistance R, or magnetic permeability μ. With respect to the arrangement, as mentioned above, induced current I_{ind}(t) is a function of the angle between the unit normal vector of the cross-section and the magnetic field, and the strength of the magnetic field B. The latter parameter is notably related to the distance between elongated conductor 601 and coil 605, and since both magnetic fields generated by elongated conductor 601 and coil 605 are decreasing functions of the distance to elongated 601 or coil 605, the shorter the gap distance, the higher the induced current value. In terms of the angle α between the unit normal vector of the cross section and the magnetic field, the induced current is maximum when α=0. The angle α is related to the angle between the longitudinal axis of the elongated conductor 601 and the longitudinal axis 607 of the coil 605 β according to

$$α = \frac{π}{2} - β .$$

Consequently, the induced current is maximum when the longitudinal axis of the elongated conductor 601 and the longitudinal axis 607 of the coil 605 are perpendicular (α=0, β=π/2), as shown in FIGS. 6A-D. However, any nonzero angle less than π/2 between the longitudinal axes results in a non-null induced current. When the axes are parallel

$$( α = \frac{π}{2} , β = 0 )$$

then the induced current is null. With respect to the characteristic parameters, the induced current value is an increasing function of the cross-sectional area A and the magnetic permeability μ, and a decreasing function of the electrical resistance.

It should therefore be appreciated that by carefully varying the afore-mentioned parameters, it may be possible to obtain a constant value of induced current I_{ind}(t). Moreover, two elongated conductor/coil couples may generate substantially the same induced current I_{ind}(t) value when provided with the same source current I(t), even if they are arranged differently, or have different characteristic parameters. For example, if a first elongated conductor/coil pair is separated by a first gap distance and a second elongated conductor/coil pair is separated by a second gap distance greater than the first gap distance, with the same source current I(t) flowing in the first and second elongated conductor, an equal amount of induced current I_{ind}(t) may be generated in both coils if the second coil has a larger cross-sectional area, lower resistance, a better oriented longitudinal axis, or a core material with a higher permeability to account for the fact that the magnetic field strength across the coil is lower due to the higher gap distance.

### Implementations of the Assembly

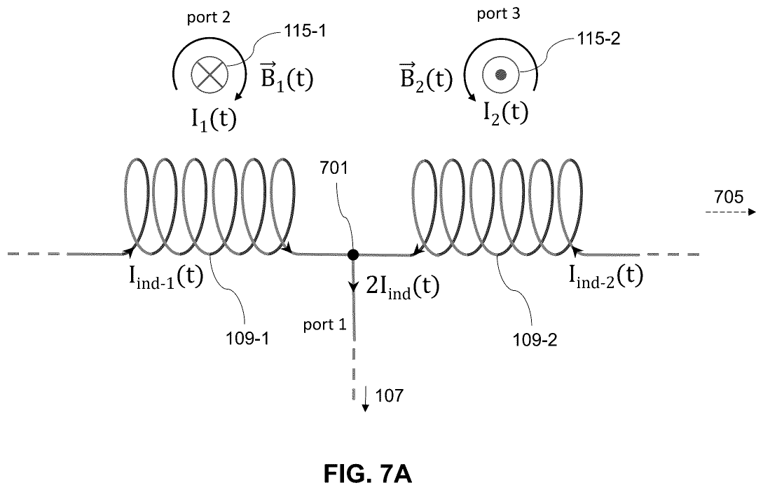

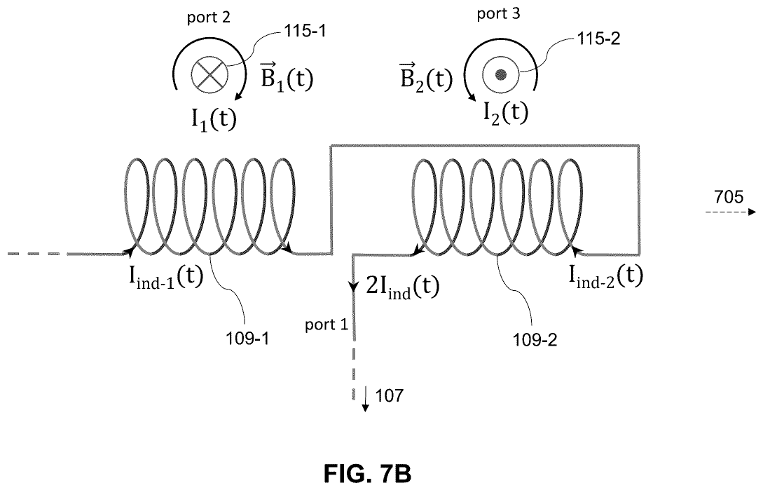

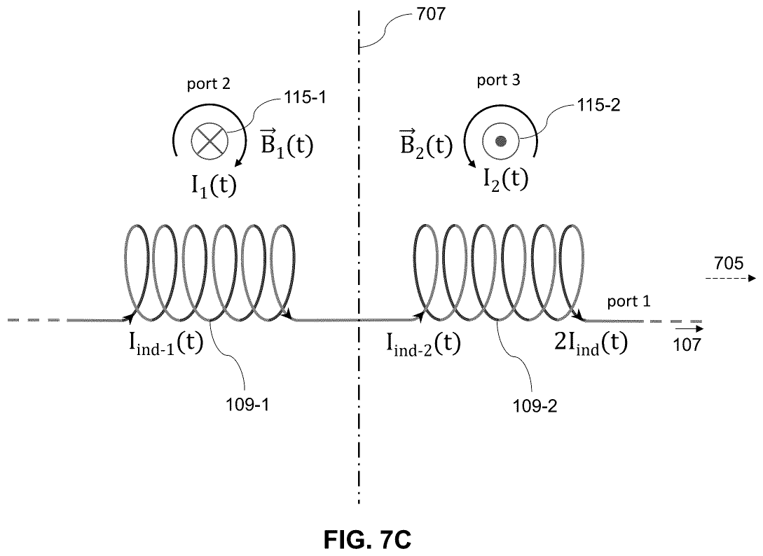

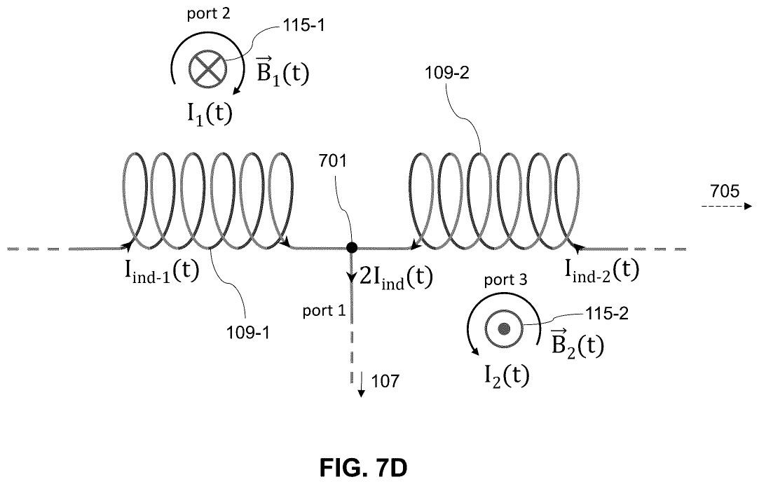

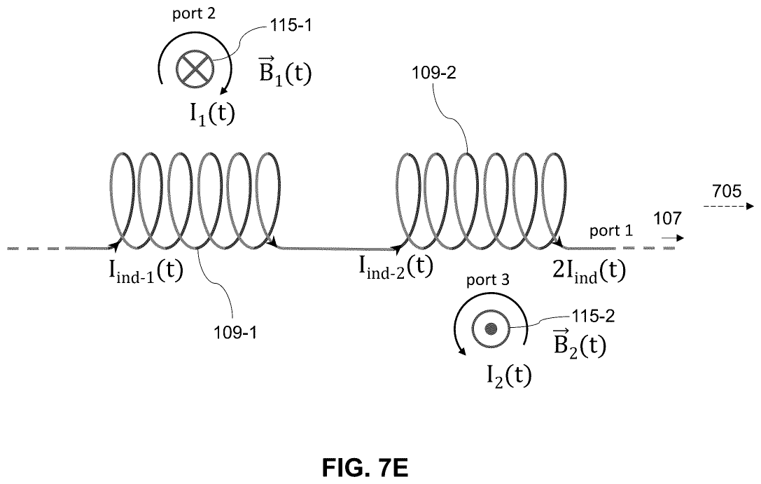

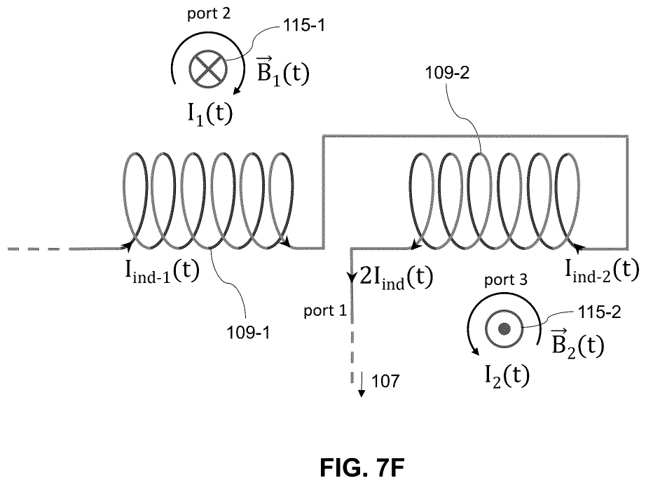

As described in the previous sections, there are several possible implementations of bus antenna 115 and module antenna 109, to obtain an induced current in each one of the transmission lines of bus antenna 115, achieved by the coupling of each transmission line to its adjacent coil, in accordance with different embodiments of the disclosure. The induced currents in each transmission line of bus antenna 115 have a substantially identical magnitude. Alternatively, it is also possible to obtain an induced current having a substantially identical magnitude in each one of first 109-1 and second 109-2 coils of the bus antenna 115, caused by the coupling of each transmission line to its adjacent coil. FIGS. 7A-F illustrate different exemplary configurations of the bus/module antenna assembly, consistent with embodiments of the present disclosure. The illustrated assemblies all comprise a module antenna 109 comprising first 109-1 and a second 109-2 air core coils sharing a longitudinal axis 705. The coils 109-1, 109-2 have the same circular cross-sectional area, the same number of turns of electrical conductor and the same electrical resistance. The illustrated bus antenna 115 comprises two identical transmission lines 115-1, 115-2 having the same cross-sectional area, the same electrical resistance and the same magnetic permeability. Also, each one of the bus antenna transmission lines 115-1, 115-2 is located equidistant relative to a different one of the coils of module antenna 109. Each bus antenna transmission line 115-1, 115-2, has a longitudinal axis that is arranged perpendicular to the longitudinal axis 705 of its respective adjacent coil. FIGS. 7A-F illustrate the induced currents I_{ind-1}(t) and I_{ind-2}(t) generated respectively in first 109-1 and second 109-2 coils, when source currents I₂(t) and I₁(t) are flowing in transmission lines 115-1 and 115-2. In accordance with some embodiments, source currents I₁(t) and I₂(t) share a substantially identical magnitude, but have opposite phases. The arrow convention is used to illustrate the direction of current in the enclosed figures, i.e. I₁(t) flows outwards of FIGS. 7A-F and I₂(t) flows inwards to FIGS. 7A-F. Accordingly, the magnetic field generated by each bus antenna transmission line \vec{B}₁(t) and \vec{B}₂(t) are substantially identical in magnitude, but rotate in different directions. Induced currents I_{ind-1}(t) and I_{ind-2}(t) share a substantially identical magnitude I_{ind-1}(t)≈I_{ind-2}(t)≈I_{ind}(t) such that when the two induced currents are combined, at the unbalanced port, I_{ind-1}(t)+I_{ind-2}(t)≈2I_{ind}(t).

In the embodiment of FIG. 7A first 109-1 and second 109-2 coils are wound along a same direction of rotation (right-handed with respect to longitudinal axis 705) and are connected to extraordinary node 701, forming a T-junction. First coil 109-1 experiences a varying magnetic field \vec{B}₁(t) circulating from right to left, and resulting induced current I_{ind-1}(t) flows from left to right. Second coil 109-2 experiences a varying magnetic field \vec{B}₂(t) circulating from left to right, and resulting induced current I_{ind-2}(t) flows from right to left. Induced currents I_{ind-1}(t) and I_{ind-2}(t) are combined at extraordinary node 701. Using the previously described balun analogy, unbalanced port (port 1) is located at the third branch of extraordinary node 701, whereas the first and second branches are respectively connected to first 109-1 and second 109-2 coils.

In FIG. 7B, which represents an alternative configuration, first 109-1 and second 109-2 coils are wound along a same direction of rotation (right-handed with respect of longitudinal axis 703), and are connected in series. First coil 109-1 experiences a varying magnetic field \vec{B}₁(t) circulating from right to left, and resulting induced current I_{ind-1}(t) flows from left to right. Second coil 109-2 experiences a varying magnetic field \vec{B}₂(t) circulating from left to right, and resulting induced current I_{ind-2}(t) flows from right to left. Induced currents I_{ind-1}(t) and I_{ind-2}(t) are combined at the right-hand side (terminal of second coil 109-2) of first 109-1 and second 109-2 coils, where unbalanced port (port 1) sits.

FIG. 7C illustrates yet another configuration, in which first 109-1 and second 109-2 coils are wound along opposite directions of rotation (first coil 109-1 is right-handed with respect to longitudinal axis 705, and second coil 109-2 is left-handed with respect to longitudinal axis 705) and are connected in series. In this configuration, there is a plane of symmetry 707 located between transmission line 115-1 and its adjacent coil 109-1 (first coil), and transmission line 115-2 and its adjacent coil 109-2 (second coil). First coil 109-1 experiences a varying magnetic field \vec{B}₁(t) circulating from right to left, and resulting induced current I_{ind-1}(t) flows from left to right. Second coil 109-2 experiences a varying magnetic field \vec{B}₂(t) circulating from left to right, and resulting induced current I_{ind-2}(t) flows from left to right. Induced currents I_{ind-1}(t) and I_{ind-2}(t) are combined at the right-hand side (terminal of second coil 109-2) of first 109-1 and second 109-2 coils in series, where unbalanced port (port 1) sits.

FIGS. 7D-7F illustrate embodiments in which the transmission lines 115-1, 115-2 of bus antenna 115, are located on opposite sides of the coils of module antenna 109. For example, first 115-1 and second 115-2 transmission lines may be located in different parallel planes sandwiching module antenna 109. Further details of the respective embodiments follow below.

In the embodiment of FIG. 7D, first 109-1 and second 109-2 coils are wound along opposite directions of rotation (first coil 109-1 is right-handed with respect of longitudinal axis 705, and second coil 109-2 is left-handed with respect to longitudinal axis 705) and are connected to extraordinary node 701. First coil 109-1 experiences a varying magnetic field \vec{B}₁(t) circulating from right to left, and resulting induced current I_{ind-1}(t) flows from left to right. Second coil 109-2 experiences a varying magnetic field \vec{B}₂(t) circulating from right to left, and resulting induced current I_{ind-2}(t) flows from right to left. Induced currents I_{ind-1}(t) and I_{ind-2}(t) are combined at extraordinary node 701. Unbalanced port (port 1) is located at the third branch of extraordinary node 701, whereas the first and second branches are connected respectively to first 109-1 and second 109-2 coils.

In the embodiment of FIG. 7E, first 109-1 and second 109-2 coils are wound along a same direction of rotation (right-handed with respect of longitudinal axis 703) and are connected in series. First coil 109-1 experiences a varying magnetic field \vec{B}₁(t) circulating from right to left, and resulting induced current I_{ind-1}(t) flows from left to right. Second coil 109-2 experiences a varying magnetic field \vec{B}₂(t) circulating from right to left, and resulting induced current I_{ind-2}(t) flows from left to right. The combined induced currents I_{ind-1}(t) and I_{ind-2}(t) are output at the right-hand side (terminal of second coil 109-2) of second coil 109-2 where unbalanced port (port 1) sits.

In the embodiment of FIG. 7F, first 109-1 and second 109-2 coils are wound along opposite directions of rotation (first coil 109-1 is right-handed with respect of longitudinal axis 703 and second coil 109-2 is left-handed with respect to longitudinal axis 703), and are connected in series. First coil 109-1 experiences a varying magnetic field \vec{B}₁(t) circulating from right to left, and resulting induced current I_{ind-1}(t) flows from left to right. Second coil 109-2 experiences a varying magnetic field \vec{B}₂(t) circulating from right to left, and resulting induced current I_{ind-2}(t) flows from right to left. The combined induced currents I_{ind-1}(t) and I_{ind-2}(t) are output at the right-hand side (terminal of second coil 109-2) of second coil 109-2 where unbalanced port (port 1) sits.

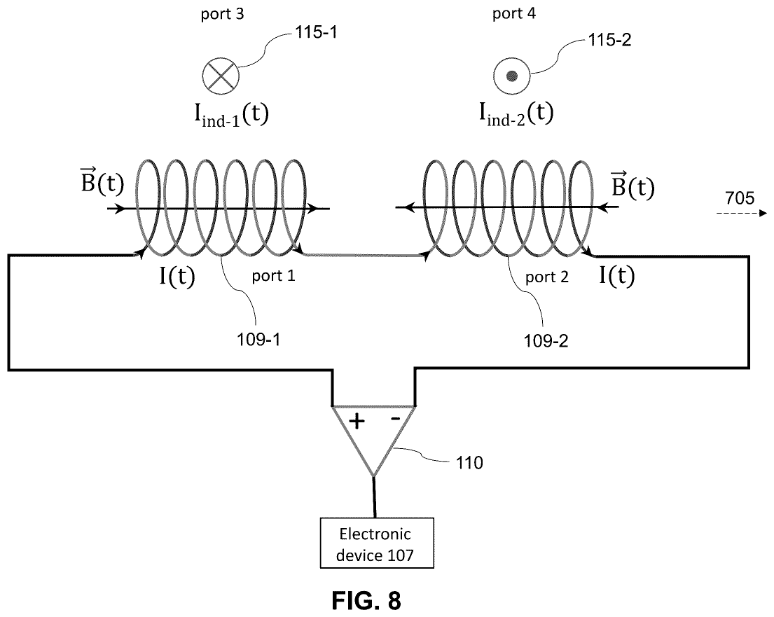

FIG. 8 illustrates yet a further configuration of first 109-1 and second 109-2 coils and bus antenna transmission lines 115, in which the coils 109 and bus antenna transmission lines 115 are not configured as a balun. Instead, the coils 109 and bus antenna transmission lines are configured as a four-port coupler. In this embodiment, electronic device 107 is connected to a differential output block, which may relate to phase splitter 110. When a signal is transmitted from the CMD 105, or more specifically from module antenna 109 to bus antenna 115, phase splitter 110 is configured to receive a single input signal V_{S} and to output a pair of differential signals V_{S}/2 and −V_{S}/2, which translates into an alternating current I(t), flowing form the “+” pole of phase splitter 110 to the “−” pole. Second coil 109-2 is wound in an opposite direction to first coil 109-1. In this way, the direction of the magnetic fields in first coil 109-1 and second coil 109-2 are opposite. Consequently, the induced current in the first 115-1 and second 115-2 bus antenna transmission lines are also opposite in direction, forming a differential pair of signals. In this embodiment first coil 109-1 may be considered as port 1, second coil 109-2 may be considered port 2, first transmission line 115-1 may be considered port 3, and second transmission line 115-2 may be considered port 4. The signal input to port 1 is output at port 3, and the signal input to port 2 is output to port 4. The function of phase splitter 110 may be provided by any device that outputs a differential pair of signals for a given input signal, including a balun.

### Printed Circuit Board Implementation

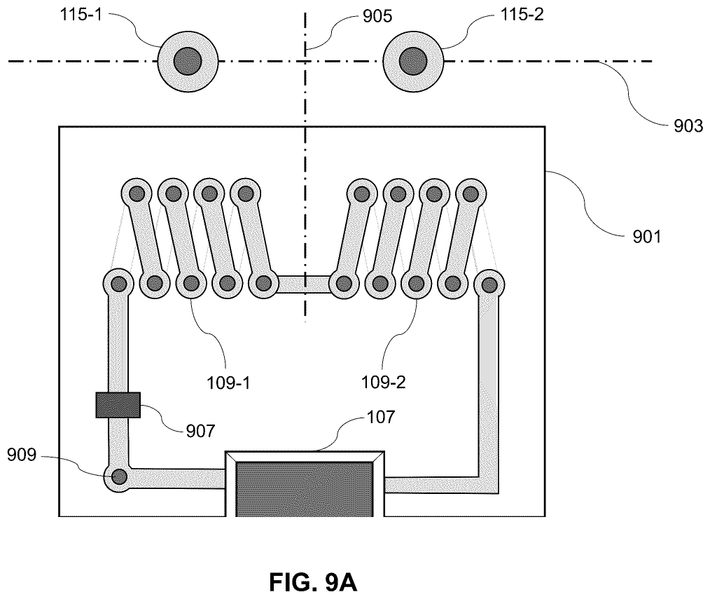

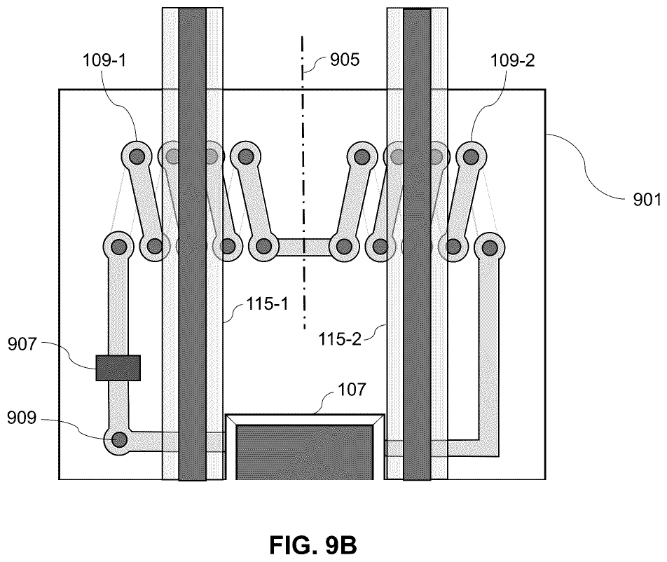

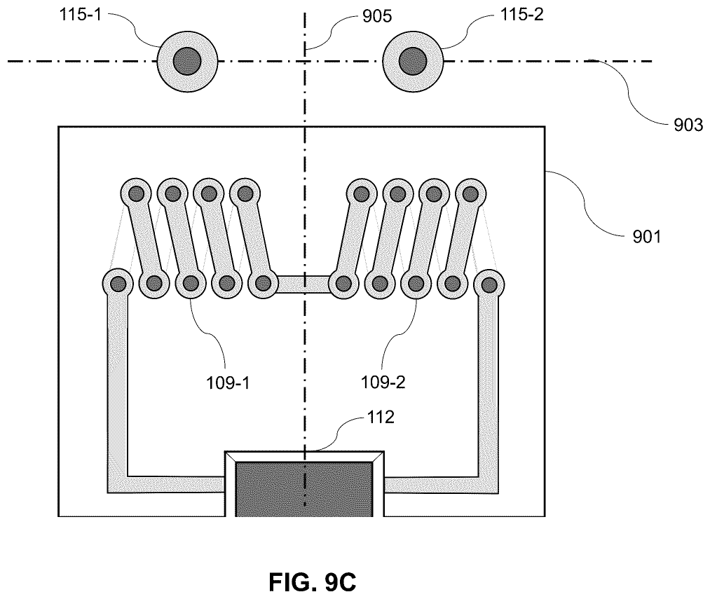

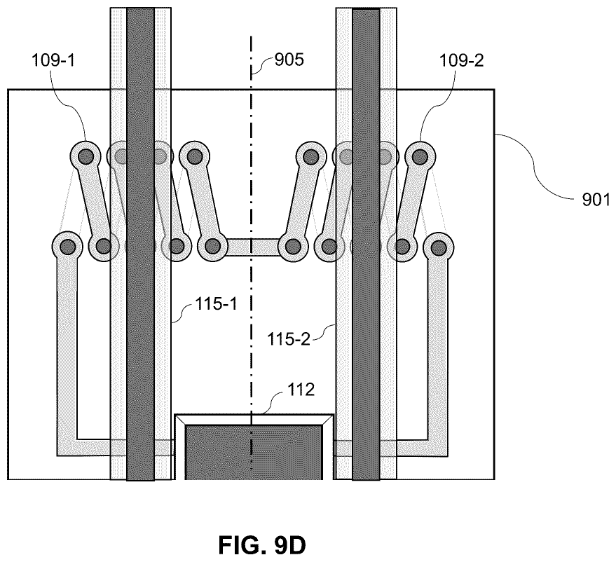

In accordance with some embodiments, the assembly comprising bus antenna 115 and module antenna 109 may comprise a printed circuit board (PCB). In accordance with some embodiments, the PCB may comprise electronic device 107 and module antenna 109. In such embodiments, first 109-1 and second 109-2 coil are comprised in the PCB. For example, first 109-1 and second 109-2 coils may relate to air-core coils or ferrite core coils soldered on a surface of the PCB. Alternatively, first 109-1 and second 109-2 coils may be integrated into the PCB substrate. For example, in accordance with some embodiments, first 109-1 and second 109-2 coils may be formed by a plurality of tracks and vias. FIGS. 9A-9D illustrate PCBs 901 comprising electronic device 107, and module antenna 109. First 109-1 and second 109-2 coils may be formed by a plurality of tracks and vias. The arrangement of bus antenna 115, and transmission lines 115-1, 115-2 relative to first 109-1 and second 109-2 coils, is similar to the one represented in FIG. 7C, and has a plane of symmetry 905 extending into the page. Additionally, coils 109 comprise a ground connection 909, and capacitor 907, thereby ensuring that coils 109 and electronic device 107 form an unbalanced circuit. The ground connection may be achieved by extending a via or track from one of the coils to a ground plane in the PCB 901. An advantage of incorporating the module antenna 109 and electronic device 107 in a PCB, as illustrated in FIGS. 9A-9D, is the reduced footprint with respect to an embodiment in which the module antenna 109 and electronic device 107 are separately affixed to a battery module. Additionally, incorporating the module antenna 109 and electronic device 107 into a PCB facilitates assembly. Accordingly, embodiments in which module antenna 109 and electronic device 107 are comprised in a PCB may allow battery system 100 to be more compact, and incidentally as a result of the reduced footprint of the PCB, a greater number of battery modules 103 may be stacked within a battery system, without increasing its volume. The bus antenna 115 may extend in a plane orthogonal to the plane of PCB 801, as illustrated in FIG. 9A, or parallel to the plane of PCB 901, as illustrated in FIG. 9B. The PCB material may be selected based on the required insulating characteristics. For example, and as explained previously, required clearance and creepage distances may be specified by the relevant standard, and consequently the PCB material may be selected for compliance with the relevant standard. The tracks and/or vias of the PCB including the vias and/or tracks used to fashion coils 109, may be coated by an insulating material to further improve the creepage and clearance distance. Similarly, the tracks and/or vias may be embedded within the PCB to further improve the creepage and clearance distance.

FIGS. 9C and 9D illustrate embodiments in which the electromagnetic coupling is as illustrated in FIG. 8, albeit the functionality of phase splitter 110 of FIG. 8 is provided at electronic device 112. For example, electronic device 112 may be provided with local means for replicating the functionality of phase splitter 110. It is envisaged that electronic device 112 may comprise a phase splitter within it.

In yet a further embodiment, it is envisaged that the bus antenna transmission lines may also be incorporated in a PCB, along with the module antenna and electronic device. In such embodiments, it is envisaged that the PCBs affixed to neighbouring battery modules are electrically connected, to ensure that the bus antenna transmission lines form a continuous electrical path across all battery modules in the battery system.

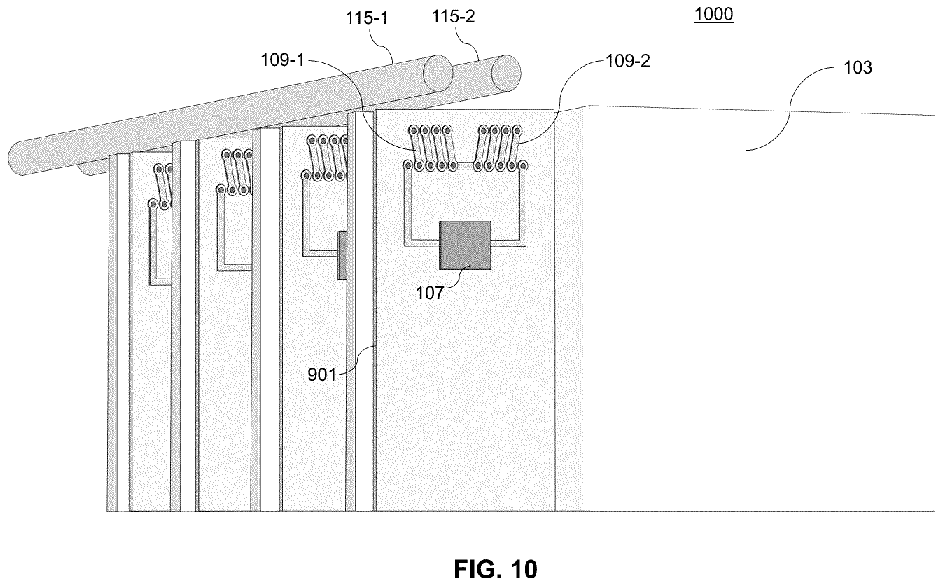

FIG. 10 is a schematic perspective illustration of a battery pack 1000, comprising a plurality of battery modules 103, each having a PCB 901 affixed to a surface. Bus antenna 115, and specifically first 115-1 and second 115-2 transmission lines may extend in a plane orthogonal to the surface of the battery module 103 PCB 901 is affixed to. Incidentally, the configuration of bus antenna 115 relative to module antenna 109 of FIG. 10 illustrates one of the advantages associated with embodiments of the present disclosure-namely, that electromagnetic coupling of the module antenna to the bus antenna may be achieved via a wide range of different configurations of bus antenna to module antenna. Thus, the herein disclosed embodiments may be implemented in a wide range of different form factors of battery pack, and more specifically may be implemented in combination with a wide range of different relative orientations of battery modules within a battery pack.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives or equivalents to the provided embodiments. The examples discussed herein were chosen and described in order to explain the principles and the nature of various example embodiments, and their practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same or functionally equivalent item of hardware.

The various example embodiments described herein are described in the general context of method steps or processes, which may be implemented in one aspect by a computer program product, embodied in a computer-readable medium or a non-transitory computer-readable medium, comprising computer-executable instructions, such as program code, executed by computers or one or more processors in networked environments. A computer-readable medium or a non-transitory computer readable medium may comprise removable and non-removable storage devices comprising, but not limited to, Read Only Memory (ROM), Random Access Memory (RAM), compact discs (CDs), digital versatile discs (DVD), flash memories, etc. Generally, program modules may comprise routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specifications, there have been disclosed example embodiments. However, many variations and modifications can be made to these embodiments. Accordingly, although specific terms are employed, they are used in a generic and descriptive sense only and not for purposes of limitation, the scope of the embodiments being defined by the following claims.

1. An assembly for use with a battery pack comprising a plurality of battery cells, the assembly suitable for enabling communication between an electronic device and a radio transceiver located remotely from the electronic device, the assembly comprising:
a module antenna operatively connected to the electronic device, the module antenna comprising a first coil and a second coil of an electrical conductor;
a bus antenna configured in use to provide a communication channel for the radio transceiver, the bus antenna comprising two transmission lines, each one of the transmission lines being spaced apart from and positioned adjacent to a different one of the first and second coils, to enable near-field coupling between the module antenna and the bus antenna when a transmission signal is input into either the module antenna or the bus antenna; and,
wherein the arrangement of the two transmission lines relative to the coils is such that an induced current in each transmission line caused by the coupling of each transmission line with its adjacent coil, is substantially the same in magnitude.

2. The assembly of claim 1, wherein in operation the module antenna and the bus antenna form a balun, and wherein when the transmission signal comprises an unbalanced electrical signal input in the module antenna, it is output as a balanced electrical signal in the bus antenna; or, when the transmission signal comprises a balanced electrical signal input in the bus antenna, it is output as an unbalanced electrical signal in the module antenna.

3. The assembly of claim 1 or 2, wherein for each one of the bus antenna transmission lines, a longitudinal axis of the transmission line is arranged perpendicular to a longitudinal axis of its respective adjacent coil.

4. The assembly of any preceding claim, wherein the first and second coils are configured to share a same longitudinal axis.

5. The assembly of any preceding claim, wherein the first and second coils comprise at least one of the following characteristics: a same cross-sectional coil area, a same number of turns of the electrical conductor, a same electrical resistance, a same core material.

6. The assembly of any preceding claim, wherein the bus antenna transmission lines comprise at least one of the following characteristics: a same cross-sectional area, a same electrical resistance, a same magnetic permeability.

7. The assembly of any preceding claim, wherein each one of the bus antenna transmission lines is located equidistant relative to a different one of the coils of the module antenna.

8. The assembly of any preceding claim, wherein the first and second coils are wound along a same direction of rotation.

9. The assembly of any one of claims 1-7, wherein the first and second coils are wound along opposite directions of rotation.

10. The assembly of claim 8 or 9, wherein the first and second coils are connected in series or are connected by an extraordinary node.

11. The assembly of any preceding claim, wherein the two transmission lines of the bus antenna are configured as a balanced circuit, such that an electrical signal propagating in a first one of the two transmission lines is π radians out of phase with respect to an electrical signal propagating in a second one of the transmission lines.

12. The assembly of any preceding claim, wherein each transmission line of the bus antenna is connected at one end to a termination resistor.

13. The assembly of any preceding claim, wherein a distance of separation between each one of the bus antenna transmission lines and its adjacent coil is selected to achieve a coupling strength greater than or equal to −50 dB, and less than or equal to −10 dB.

14. The assembly of claim 13, wherein a distance of separation between each one of the bus antenna transmission lines and its adjacent coil is selected to achieve a coupling strength greater than or equal to −40 dB, and less than or equal to −20 dB.

15. The assembly of claim 13 or 14, wherein the distance of separation is selected to achieve a coupling strength greater than or equal to −35 dB, and less than or equal to −25 dB.

16. The assembly of any one of claims 13 to 15, wherein the distance of separation is selected to achieve a coupling strength of −30 dB.

17. The assembly of any preceding claim, wherein each one of the bus antenna transmission lines and its adjacent coil are separated by a dielectric insulating material.

18. The assembly of claim 17, wherein the dielectric insulating material comprises any one of: air, a plastic material, a glass-filled plastic material, an epoxy composite material.

19. The assembly of claim 17, wherein the dielectric insulating material comprises any one of: polyethylene terephthalate “PET”, acrylonitrile butadiene styrene “ABS”, polytetrafluoroethylene “PTFE”, polyvinyl chloride “PVC”, polybutylene terephthalate “PBT”, polyethylene “PE”, polyamide “PA”.

20. The assembly of claim 17, wherein the dielectric insulating material comprises any one of: FR4, ceramic-filled polytetrafluoroethylene “PTFE”, ceramic laminates, mylar.

21. The assembly of any preceding claim, wherein the first and second coils are air core coils.

22. The assembly of any preceding claim, wherein the first and second coils are wound around a material.

23. The assembly of claim 22, wherein the material is at least one of: plastic insulating material, ferrite, or ceramic.

24. The assembly of any preceding claim, comprising a printed circuit board “PCB” comprising the electronic device, and wherein the PCB comprises the module antenna.

25. The assembly of claim 24, wherein the first and second coils are integrated into the PCB substrate.

26. The assembly of claim 25, wherein the first and second coils are formed by a plurality of tracks and vias.

27. The assembly of any preceding claim, wherein the first and second coils are connected to a capacitor.

28. A battery cell comprising the assembly of any preceding claim.

29. A battery pack having a plurality of battery cells and comprising the assembly of any one of claims 1 to 27, wherein each battery cell is associated with an electronic device and the assembly enables communication between each electronic device and a radio transceiver located remotely from the battery pack via the bus antenna and the module antenna.
